(19) United States
(12) Patent Application Publication
(10) Pub. No.: US 2015/0317915 A1
(43) Pub. Date: Nov. 5, 2015

(54) State Change Device And System For The Tactile Display of Information

(71) Applicant: University of Rochester, Rochester, NY (US)

(72) Inventors: Randal Crosby Nelson, Rochester, NY (US); Christina Kayastha, Rochester, NY (US); Samantha Lawrence Piccone, Rochester, NY (US)

(73) Assignee: UNIVERSITY OF ROCHESTER, Rochester, NY (US)

(21) Appl. No.: 14/701,563

(22) Filed: May 1, 2015

Related U.S. Application Data
(60) Provisional application No. 61/987,549, filed on May 2, 2014.

(51) Int. Cl. G09B 21/02

(52) U.S. Cl. CPC G09B 21/02

(57) ABSTRACT

A state change device and system for the tactile display of information is disclosed. The state change device uses a novel pin and driving coil arrangement combined with a bistable plate to create a high state and a low state where the pin either protrudes from a surface or is recessed below the surface. The state change device may be combined with other similar devices to create a Braille character and may be further combined to create a Braille reader where transient information is displayed on the Braille reader from a computing device or processor. The state change device makes possible low cost Braille displays that are reliable, compact, quickly refreshable and with more characters than current Braille displays, thus providing new life and opportunity for both the Braille alphabet and those that require the use of such.

### CROSS REFERENCE TO RELATED PATENT APPLICATIONS

This application claims priority to U.S. Patent Application Ser. No. 61/987,549 filed May 2, 2014 entitled “State Change Device And System For The Tactile Display of Information” by Nelson et al., the entire disclosure of which is incorporated herein by reference.

### BACKGROUND OF THE INVENTION

1. Field of the Invention

The present invention relates generally to a state change device, and more particularly to a device and system for the tactile display of information.

2. Description of the Related Art

Tablets and e-readers have become a staple of modern life in the Information Age. The modern world has grown accustomed to on-demand access to information that is always within arm's reach. For the blind, accessing such information involves the inefficient and often frustrating use of screen readers and the inconvenience of being tied to a computer. While there do exist some options that can dynamically display output, these bulky devices are limited in functionality and are expensive, and thus do not truly parallel the touchscreen devices that have become the status quo for the rest of the population. The difficulty of creating a device for the blind that is closer in features to today's visual electronic devices lies in efficiently producing a large number of Braille sized pins that are capable of quickly moving up and down and staying in place.

In 1960, 50% of legally blind school-age children were able to read Braille. But, in 2007, only 10% used Braille as their primary reading language (Facts and Figures on Americans with Vision Loss, 2008). The use of Braille is on the decline, and it is easy to see why. Braille books are incredibly large and expensive. For example, a Braille edition of the Harry Potter series consists of 56 volumes, and a single text book can cost $1000. A small book, less than half an inch thick, when translated into Braille, results in an 11 by 11.5 inch book (the standard size of Braille book paper) that is around 2 inches thick. Students are now turning to MP3 players, audio books, and computers with screen readers as a more affordable, accessible, and convenient option, disregarding the need to learn Braille. Braille has become regarded by some as arcane and obsolete. A stigma surrounding Braille has developed, with the idea that using Braille somehow makes a person “more blind.” So, in the modern era, why does Braille really matter?

Audio learning is certainly not considered sufficient for sighted children, and neither should it be for blind children. A child that only listens to learn is not taught spelling, punctuation, or syntax, and cannot fully engage with the material being taught. Additionally, Braille can communicate information that audio cannot, such as math and science notations. The impact of Braille on the blind community is evident in employment statistics. In the United States, only one third of blind adults are employed. Of those that are employed, 93% read and write Braille. Braille is essential for the blind to be afforded the same opportunities as the sighted population.

What is therefore needed is a device for the tactile display of information that can be produced at low cost and can be used to produce a large display of tactile information such as Braille or other relief graphics.

It is thus an object of the present invention to provide a device that displays tactile information and can be rapidly changed or refreshed to provide new tactile information. It is another object of the present invention to provide a device that can be produced at a reasonable cost and can be produced in volume. It is another object of the present invention to provide a device that can be combined with a plurality of other similar devices to create a tactile display that is convenient to use, portable, and easy to operate. These and other objects of the present invention are not to be considered comprehensive or exhaustive, but rather, exemplary of objects that may be ascertained after reading this specification, claims and the accompanying drawings.

### BRIEF SUMMARY OF THE INVENTION

In accordance with the present invention, there is provided a state change device comprising a guide containing a high side driving coil and a low side driving coil; a drive pin positioned within the guide and able to pass through the bore of the high side driving coil and the low side driving coil; a pin tip formed with the drive pinto provide tactile sensation when encountered by a human finger; and a bistable plate between the high side driving coil and the low side driving coil with an opening to allow the pin to pass through the bistable plate.

In some embodiments of the present invention the pin is magnetic. In some embodiments of the present invention, the pin has a rounded tip. The state change device may be combined with other state change devices to create a Braille character device. The state change device may also be combined with other state change devices to create a system for the tactile display of information.

The foregoing paragraph has been provided by way of introduction, and is not intended to limit the scope of the invention as described by this specification, claims and the attached drawings.

### BRIEF DESCRIPTION OF THE DRAWINGS

The invention will be described by reference to the following drawings, in which like numerals refer to like elements, and in which:

FIG. 1 depicts a perspective view of a single Braille character embodiment of the state change device of the present invention;

FIG. 2 is a plan view of the Braille character embodiment of FIG. 1;

FIG. 3 is a side view of the Braille character embodiment of FIG. 1;

FIG. 4 is an alternate side view of the Braille character embodiment of FIG. 1;

FIG. 5 is a cross sectional view of the Braille character embodiment of FIG. 1 taken along line A-A of FIG. 2;

FIG. 6 is an exploded view of the Braille character embodiment of FIG. 1;

FIG. 7 is a view of an exemplary tactile display of the present invention;

FIG. 8 depict various printed circuit board layouts of drive inductors of the present invention;

FIG. 9 depict additional exemplary printed circuit board layouts of drive inductors of the present invention;

FIG. 10 depicts an exemplary printed circuit drive inductor of the present invention;

FIG. 11 depicts another drive inductor of the present invention; and

FIG. 12 depicts one half of a 4 pin actuator driver circuit.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification, claims and drawings attached hereto.

### DESCRIPTION OF THE PREFERRED EMBODIMENTS

A state change device is described herein. The state change device may be combined with other state change devices to create a Braille character device. The state change device may also be combined with other state change devices to create a system for the tactile display of information. Such a system may be used as an electronic Braille reader, or may, in some embodiments of the present invention, be used for other purposes, such as the display of other information such as graphical or diagrammatic information. The display of information may be transient where the system is integrated with or interlaced with a computer or computer network. Such a tactile display may be a standalone device or may be a peripheral or similar output unit to another computer, computing device or network.

The state change device makes it possible to create a full page Braille display using solid state material and a single moving part per point. The device is compact, scaleable to full page arrays of thousands of points. The device and related display are quickly refreshable, with a single driver capable of refreshing 500 points per second, and with sectioned parallel drivers capable of providing taster refresh times on large displays. The device is low cost and reliable, providing new life and opportunity for the Braille alphabet.

In one application, the state change device is combined with other state change devices to create a Braille character having a matrix of 3×2 or 4×2 state change devices. The attached figures depict by example, and not limitation, one embodiment of the state change device of the present invention configured as a Braille character device. When spacing each state change device at, for example, 0.1 inches in both the x and y direction, multiple matrix dimensions can be supported on a single display. Other displays and configurations, as well as variations to the state change device are considered to be within the spirit and broad scope of the present invention. For example, the pin tips of each state change device may be separated by a standardized distance. A standard distance may be, for example, a Braille standard distance where that distance is defined by the appropriate standards body that may be regional or country specific. In addition, the protrusion of each pin tip that makes up the Braille character protrudes a Braille standard distance, again where that distance is defined by the appropriate standards body that may be regional or country specific. In addition, the state change device may be used for other purposes, such as, but not limited to, switching, valves, actuators, drivers, and the like. Further, in some embodiments of the present invention the state change device may be of a size larger or smaller than that described herein, and may, in some embodiments of the present invention, be implemented as a MEMS (micro-electro-mechanical system) device.

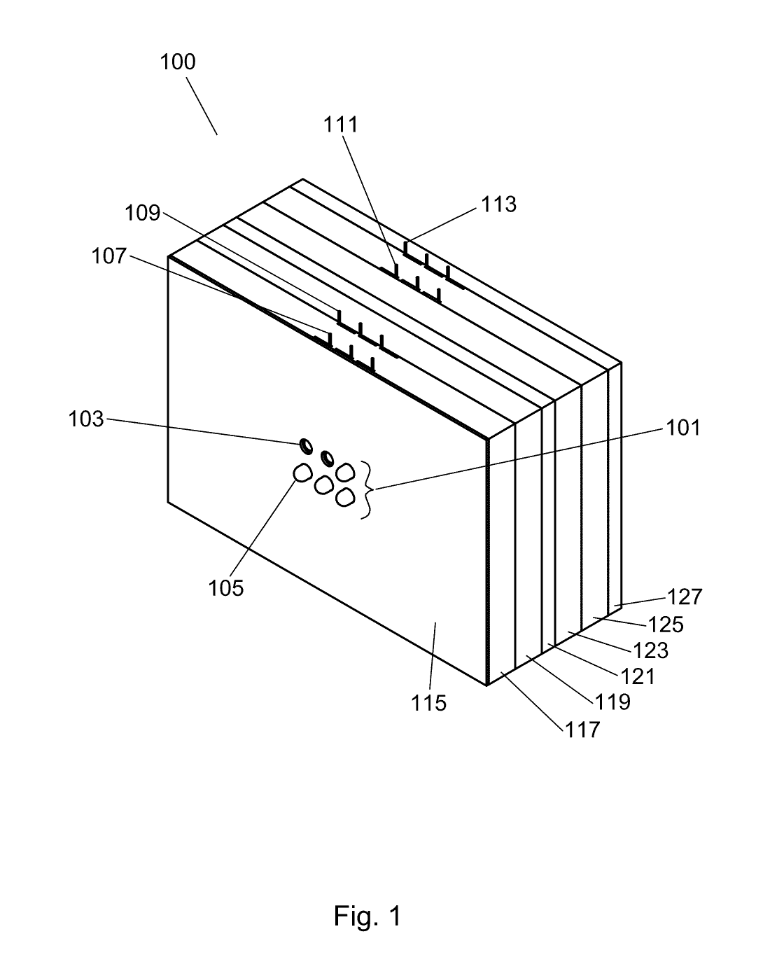

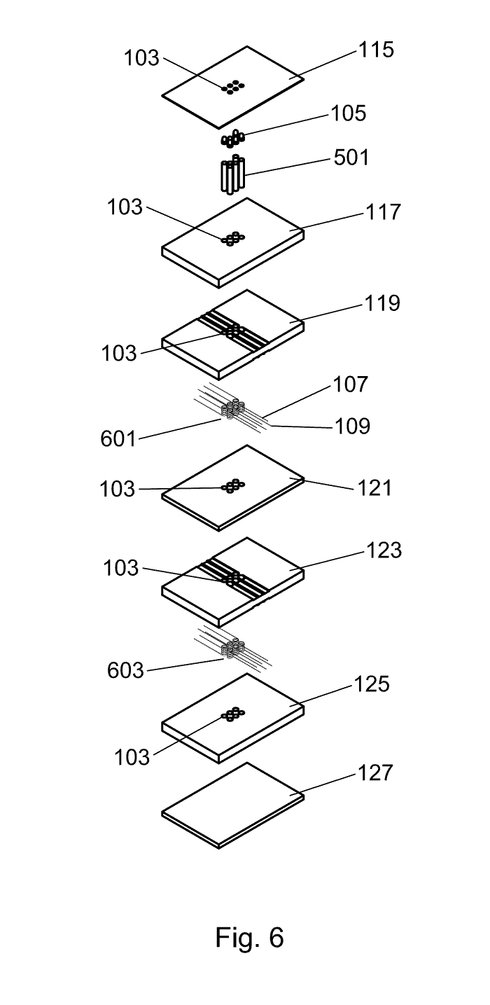

Turning first to FIG. 1, a perspective view of a single Braille character embodiment of the state change device of the present invention can be seen. A Braille character 101 can be seen that comprises a 3×2 matrix of state change devices of the present invention. The Braille character is transiently created by the protrusion or retraction of a pin tip 105 that is preferably rounded and that is of the dimensions normally used for the constituent elements of a Braille character. The pin tips 105 rest in a guide 103 so that two states may exist—the presence of a pin tip 105 or the absence of a pin tip 105. Each pin tip is separated by a distance that has come to be known as a Braille standard, such as, but not limited to, 0.1 inch. The pin tip is a rounded surface such as a spherical surface that provides tactile sensation when encountered with a reader's lingers. The pin itself is made from a material suitable for interaction with the coils of the present invention, as will be further described herein. The pin may, for example, be made from a magnetic material, and may be machined, cast, or the like. A magnetic pin allows for interaction with a bistable plate (see 121 in FIG. 1) such that current can be removed from a driving coil and result in a stable pin state (the pin remains in a high state or a low state depending on the drive coil that was energized). The pin tip, although it may also be made from the same material as the pin itself, may also be made from a material such as a plastic that is more comfortable and receptive to a user. The pin tip 105 may be glued, welded, fused, mechanically coupled, or otherwise adhered to the pin itself. As will be further described herein, and as more clearly seen by way of FIG. 6, layers of material containing guides 103 are assembled together to create a structure that contains the various components of the state change device. A cover layer 115 may be applied to provide a surface for the device that retains the drive pins and related pin tips. Such a cover layer may be made from, for example, a non-magnetic metal such as, for example, brass, stainless steel, titanium, and the like. Optionally, a cosmetic covering may be applied that may include, for example, a plastic such as acrylonitrile butadiene styrene (ABS), polyethylene, polypropylene, polystyrene, polyvinyl chloride, polytetrafluoroethylene, and the like. Bioplastics may also be used in some embodiments of the present invention. For convenience while describing the present invention, the terms “high side” and “low side” are used merely to indicate the two sided configuration of the magnetics of the present invention. Essentially there is a coil on either end of a magnetic or ferromagnetic pin with a bistable plate placed between each of the two coils. When either of the coils is energized, it provides linear motion of the pin to either raise the pin tip or lower the pin tip (a “high” state and “low” state). Thus, one side of the bistable plate is termed the high side and the other side of the bistable plate is termed the low side. These terms are arbitrary, and the direction that each coil is wound and the direction of current flow of each coil determines the direction that the pin travels and the resulting high state or low state of the pin tip. Therefore, in keeping with this convention, a high side first layer 117 and a high side second layer 119 can be seen in FIG. 1 and more clearly seen in the exploded diagram of FIG. 6. There may be more or fewer high side layers in various embodiments of the present invention. The layers may be made from a plastic such as acrylonitrile butadiene styrene (ABS), polyethylene, polypropylene, polystyrene, polyvinyl chloride, polytetrafluoroethylene, and the like. Bioplastics may also be used in some embodiments of the present invention. Other materials, for example, include fiberglass or fiberglass-epoxy composites, and the like. Between or through the various layers is a coil, in the high side layers there is a high side driving coil where in FIG. 1 a high side driving coil positive lead 107 and a high side driving coil negative lead 109 can be seen. The coils can be clearly seen in the exploded view in FIG. 6. The layers each have a guide 103 such as a hole, aperture, conduit or the like. The guide in each layer contains the drive pin 501 (see FIG. 5) that in turn is connected to, or an integral part of, the pin tip 105. The guide is of sufficient size to allow the pin and pin tip to move freely in a linear direction to create a high state and a low state based on the position of the pin tip 105 in the guide 103. A bistable plate 121 can be seen separating the high side and the low side of the device. The bistable plate 121 is made from a ferromagnetic steel such as a mild steel that preferably does not retain a residual magnetic field. The bistable plate 121 may be, for example, 16 gauge mild transformer steel. The low side also has a low side second layer 123 and a low side first layer 125, and may have additional or fewer layers and is similar to that of the high side layers. A hack cover 127 may also be provided to retain the drive pins and may optionally have an aesthetic covering, and may be similar to that of the cover layer 115. Between or through the various layers is a coif in the low side layers there is a low side driving coil where in FIG. 1 a low side driving coil positive lead 111 and a low side driving coil negative lead 113 can be seen. The driving coils may be wire wound and made from varnished or insulated copper wire, or may, in some embodiments of the present invention that will be further described later in this specification, be made as printed circuit board traces or traces on thick film hybrid circuits or the like.

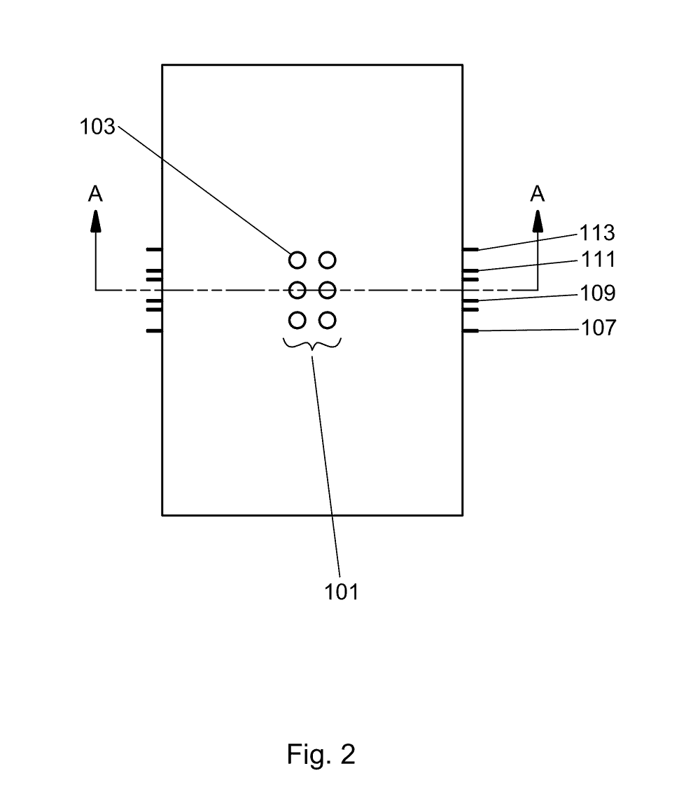

FIG. 2 is a plan view of the Braille character embodiment of FIG. 1 where guides 103 forming a Braille character 101 can be seen. Further, the coil leads can be seen. The coil leads may be discrete wires as depicted in FIG. 2, or may, in some embodiments of the present invention, be printed circuit board traces, metallic contacts, pads, connectors, or the like.

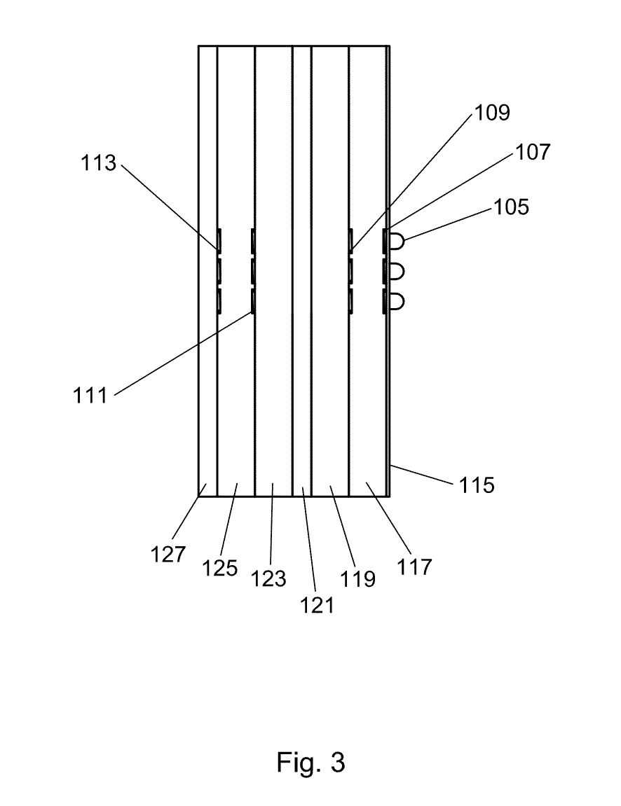

FIG. 3 is a side view of the Braille character embodiment of FIG. 1 where the layers and the bistable plate can be seen along with pin tips 105 in the high state, raised from the surface of the device.

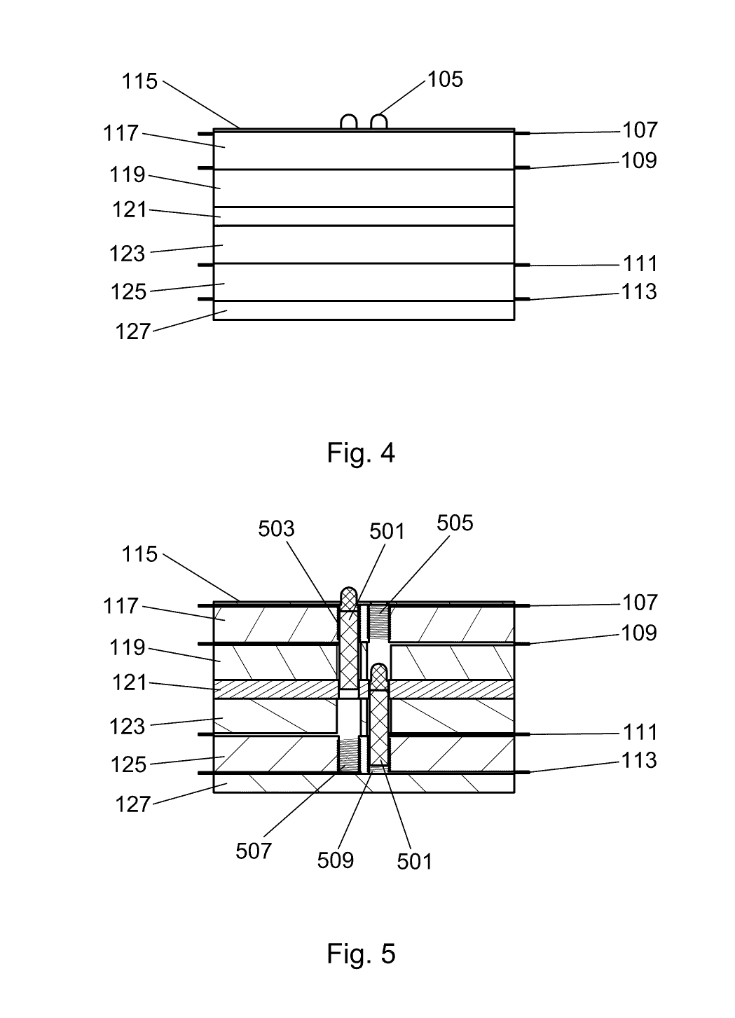

FIG. 4 is an alternate side view of the Braille character embodiment of FIG. 1 where the device is rotated ninety degrees with respect to FIG. 3. Again, the layers can be seen.

FIG. 5 is a cross sectional view of the Braille character embodiment of FIG. 1 taken along line A-A of FIG. 2. In FIG. 5, one of the drive pins 501 is in the high state and one of the drive pins 501 is in the low state. Each drive pin 501 is made from a magnetic or ferromagnetic material. Suitable magnetic materials include alnico magnets, rare earth magnets (Neodymium, Samarium-cobalt, for example), or the like. In some embodiments of the present invention, the magnets may be replaced with a ferromagnetic material or at least made partly of a ferromagnetic material. In some embodiments of the present invention, the drive pin 501 may contain a ferromagnetic layer, plate, or component. As seen in FIG. 5, in some embodiments of the present invention the pin tip 105 has a taper, flange, or other such retention structure to prevent the pin tip 105 from traveling too far out of the guide or possibly exiting the guide altogether. This flange, taper or similar structure interacts with the cover layer 115 to provide retention of the pin and pin tip in the guide. In some embodiments of the present invention, retention of the drive pin 501 is accomplished through the use of a hole slightly smaller than the diameter of the drive pin, for example, a 0.058 inch hole. The bistable plate 121 interacts with the magnetic drive pin 501 to allow the pin to be stable in the low state as well as the high state. Stability of the pin 501 means that it does not move to another unintended state without activation of one of the driving coils. This allows the pin tip 105 to be touched without retracting and resulting in an unintended state. Since the drive pin is not stable when it is pushed out of position from the top by a user. It will bounce back into place, thus providing a sort of self healing or self correcting Braille dot. The drive pin 501 is the single moving part for each device and may be, for example and not limitation, 0.0625 inches in diameter by 0.25 inches long. The combined thickness of the layers should preferably be around twice the length of the pin in some embodiments of the present invention. The guide 103 should preferably be slightly larger in diameter than the diameter of the drive pin 501. For example, a 0.0625 inch drive pin and a 0.065 inch diameter guide. Each drive pin 501 is provided with linear motion by way of a coil. As seen in FIG. 5, a high side driving coil 503 can be seen and a corresponding low side driving coil 507 can also be seen. By energizing the high side driving coil 503, the corresponding pin 501 is pulled upward and through the coil 503 to achieve a high or raised state. This state is analogous to a dot in a Braille character. The pin 501, through the action of the energized high side driving coil 503, is moved through the bistable plate 121 to a position where the coil can be de-energized and the pin 501 will remain in the high or raised state. Alternatively, energizing the low side driving coil 507 will pull the pin 501 downward past the bistable plate 121 and the pin 501 will now be in the low or non-raised state for use in forming a Braille character. The inter action of the bistable plate 121 and the pin will once again allow current to be removed from the low side driving coil 507 such that the low or non-raised state will remain. This novel interaction is used for other pins that make up corresponding Braille characters. For example, the adjacent pin depicted in FIG. 5 also employs a high side driving coil 505 and a low side driving coil 509. The coils can be wire wound, or may, in some embodiments, be printed or otherwise created on a printed circuit board, hybrid circuit, or other substrate.

FIG. 6 is an exploded view of the Braille character embodiment of FIG. 1 showing further details of the device of FIG. 1 as well as an example of construction of the device. Of note in FIG. 6 are the visible high side driving coils 601 and the visible low side driving coils 603. The high side driving coils 601 comprise a plurality of high side driving coils such as the high side driving coils 503 and 505 depicted in FIG. 5. In a similar way, the low side driving coils 603 comprise a plurality of low side driving coils such as the low side driving coils 507 and 509 depicted in FIG. 5. The driving coils may be air wound where the drive pin 501 travels through the air core as a result of magnetic attraction or repulsion when current travels through the driving coil. The driving coils act as a solenoid to move the drive pin 501 in a linear direction. The purpose of the driving coils is to generate a controlled magnetic field for moving the drive pin 501 up or down, thus creating a high state and a low state for the pin tip 105. The driving coils may be wound from copper wire with a varnish or insulation, or may, in some embodiments of the present invention, be fabricated using multi-layer printed circuit board techniques such as depicted in FIGS. 8-11 where laminate boards and copper traces are used to create a driving coil with a hole placed in the core of the coil for placement and movement of the drive pin 501. The solenoid driving coils may be 10-30 turns and implemented as discrete components or as layers in a printed circuit board with micro-vias to connect each layer and holes bored through the center to accommodate the drive pin 501. An example of a suitable hole size is 0.065 inch. The top and bottom printed circuit board layers contain x and y array addressing lines and a surface mount diode for each coil. An example of x and y addressing that is suitable is passive matrix addressing. The diodes will sustain current on the order of tens of amperes for a few milliseconds, the overall duty cycle being in this case less than one part in one thousand. Other diode configurations may also be employed for current handling, heat, response time, and the like. It should be noted that in FIG. 6, the high side first layer 117 and the low side first layer 125 are depicted. In some embodiments, the high side first layer 117 and the low side first layer 125 may be omitted, or may be interchanged with the high side second layer 119 or the low side second layer 123.

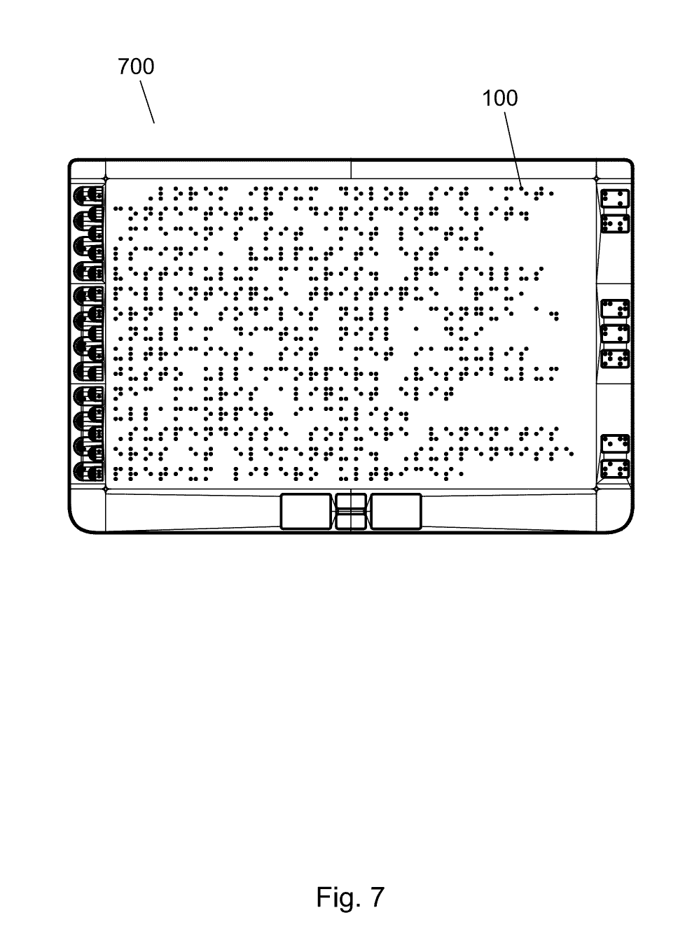

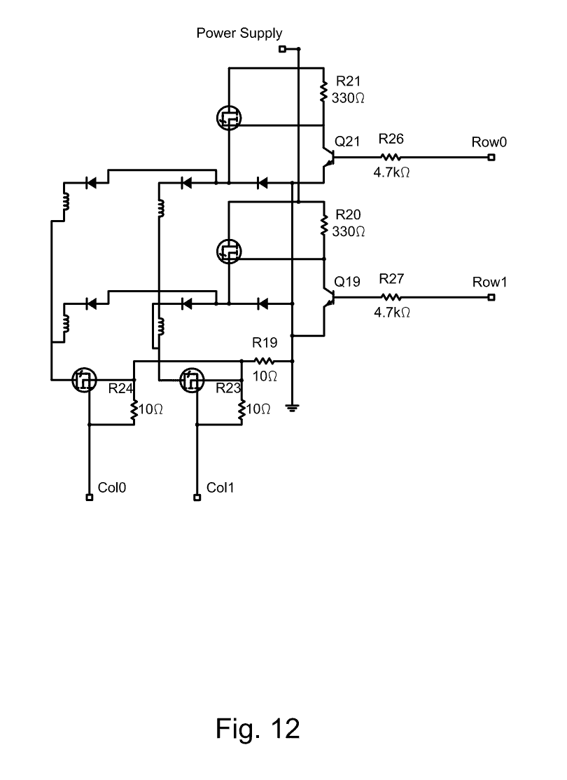

Turning now to FIG. 7, a view of an exemplary tactile display of the present invention is depicted. The tactile display 700 comprises a plurality of state change devices 100 and may, in some embodiments of the present invention, be similar to a tablet or handheld computer. In such a tactile display, cooling may be required, and may include the use of high thermal conductivity plastic, aluminum heat sinks, cooling fans, and the like. A thermal switch may also be employed to protect against overheating. Each state change device 100 requires drive current to work, and appropriate driver circuitry such as that depicted in FIG. 12 may be employed. In some embodiments of the present invention, additional energy storage devices such as capacitors are used in conjunction with the state change devices.

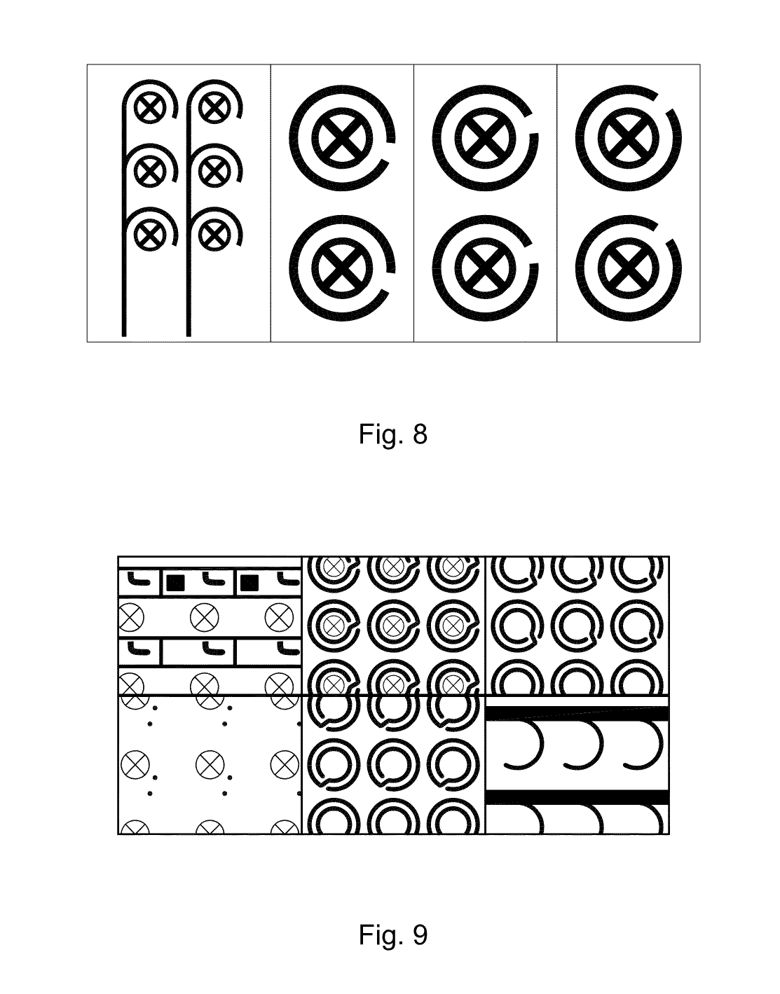

FIG. 8 depicts various printed circuit board layouts of drive inductors of the present invention. Traces are created in a multi-layer circuit board or wiring board arrangement, and through-hole vias are used to interconnect the traces to form inductors and resulting driving coils. FIG. 9 depict additional exemplary printed circuit board layouts of drive inductors of the present invention.

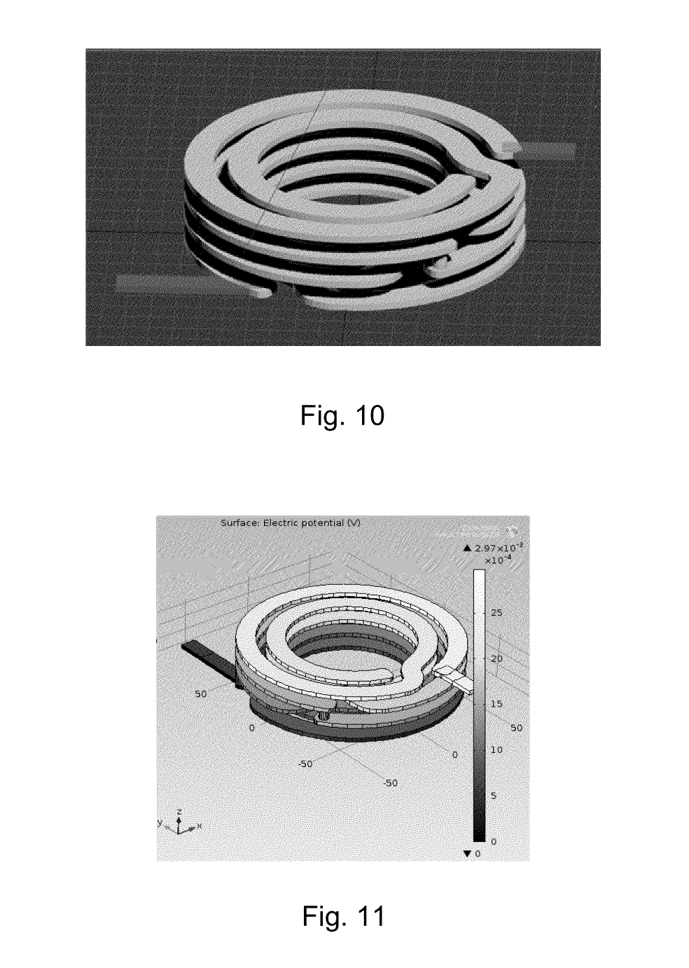

FIG. 10 depicts an exemplary printed circuit drive inductor of the present invention without the circuit board substrate visible, showing the conductive traces that are interconnected with vias from one layer to the next. FIG. 11 depicts another drive inductor of the present invention.

FIG. 12 depicts one half of a state change device driver circuit. Actuation of the driver circuit occurs through input from an addressing circuit and related microprocessor, microcontroller or the like. In FIG. 12, the driving coils are depicted as four inductors. The driver circuit typically sees a brief activation, for example, in the range of 1 millisecond, just enough time to move the drive pin of the device to a new state. It can be appreciated that the state change device is often times connected to a microprocessor or microcomputer in a way similar to the connection of a display or peripheral to the microprocessor or microcomputer. This provides functionality such as the addressing of pins that are driven between stable states by pulsed current, providing addressable pulsed current to each state change device to facilitate use in a tactile display such as that described herein. Further, to ensure proper power management in a tactile display or related device, the addressable pulsed current is not only pulsed very briefly, it can also be sequenced between state change devices. For example, in creating a Braille character by addressing a Braille character for a tactile display, one or more of the state change devices that comprise the Braille character must receive a pulse of current in order to change state. Instead of delivering pulsed current to each of the state change devices simultaneously, each of the state change devices in the Braille character may receive pulsed current sequentially. thus reducing demand for instantaneous current which could burden related circuits and power storage and delivery devices.

In operation, the drive pins are thrown from one stable position to the other by driving a current pulse in the correct direction through the driving coil on the side of the bistable plate on which the driving pin is desired to be. If the drive pin is already there, it stays. If it is not, it is pulled into the driving coil, and goes to the stable position on that side. If a current pulse is in the wrong direction, the magnet stays where it was originally. The pulses for a prototype system employing a 10-turn coil are approximately 1 Joule stored in a capacitor at 20 volts. Peak currents are a few tens of amps with a decay time of a couple of milliseconds. The driving coils are activated individually by an array addressing scheme such as, for example, passive matrix addressing. In one embodiment of the present invention, a power trace is attached to each row on one side of the printed circuit board, and one to each column on the other. A small surface-mount diode at each driving coil prevents reverse current flow. Connecting a row to one side of a pulse generator, and a column to the other (for example, by use of MOSFET switches, one per row and column) drives current only through the driving coil at that row and column. Current flow through secondary paths is prevented by the diodes. A standard array addressing scheme such as that used for visual LCD displays may be employed to avoid the need for one wire per pixel.

It is, therefore, apparent that there has been provided, in accordance with the various objects of the present invention, a state change device and system for the tactile display of information.

While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification, claims and drawings appended herein.

What is claimed is:

1. A state change device comprising:
a guide containing a high side driving coil and a low side driving coil;
a drive pin positioned within the guide and able to pass through the bore of the high side driving coil and the bore of the low side driving coil;
a pin tip formed with the drive pin to provide tactile sensation when encountered by a human finger; and
a bistable plate between the high side driving coil and the low side driving coil with an opening to allow the pin to pass through the bistable plate.

2. The state change device of claim 1, further comprising a first positive electrical lead and a first negative electrical lead making ohmic contact with the high side driving coil and a second positive electrical lead and a second negative electrical lead making ohmic contact with the low side driving coil.

3. The state change device of claim 1, wherein the high side driving coil and the low side driving coil are wire wound.

4. The state change device of claim 1, wherein the high side driving coil and the low side driving coil are contained on a printed circuit board.

5. The state change device of claim 1, wherein the high side driving coil and the low side driving coil are contained on a hybrid circuit.

6. The stale change device of claim 1, wherein the bistable plate is made from a ferromagnetic material.

7. The state change device of claim 6, wherein the ferromagnetic material of the bistable plate does not retain a residual magnetic field.

8. The state change device of claim 1, wherein the drive pin is made from a magnetic material.

9. A Braille character for a tactile display, the Braille character comprising:
a matrix of state change devices, each state change device comprising
a guide containing a high side driving coil and a low side driving coil;
a drive pin positioned within the guide and able to pass through the bore of the high side driving coil and the bore of the low side driving coil;
a pin tip formed with the drive pin to provide tactile sensation when encountered by a human finger; and
a bistable plate between the high side driving coil and the low side driving coil with an opening to allow the pin to pass through the bistable plate;
wherein the pin tip of each state change device is separated by a standardized distance.

10. The Braille character of claim 9, wherein the matrix of state change devices comprises a 3×2 matrix of six state change devices.

11. The Braille character of claim 9, wherein the standardized distance separating each pin tip is a Braille standard distance.

12. The Braille character of claim 9, wherein each pin lip protrudes a Braille standard distance when in a high state.

13. A tactile display comprising a plurality of Braille characters wherein each Braille character comprises a matrix of state change devices;
and wherein each state change device comprises a guide containing a high side driving coil and a low side driving coil;
a drive pin positioned within the guide and able to pass through the bore of the high side driving coil and the bore of the low side driving coil;
a pin tip formed with the drive pin to provide tactile sensation when encountered by a human finger; and
a bistable plate between the high side driving coil and the low side driving coil with an opening to allow the pin to pass through the bistable plate.

14. The tactile display of claim 13, wherein the pin tip of each state change device is separated by a standardized distance.

15. The tactile display of claim 14, wherein the standardized distance separating each pin tip is a Braille standard distance.

16. The tactile display of claim 13, wherein each matrix of state change devices comprises a 3×2 matrix of six state change devices.

17. The tactile display of claim 13, wherein each pin tip protrudes a Braille standard distance when in a high state.

18. The tactile display of claim 13, further comprising a cover layer surrounding the guide of each state change device.

19. The tactile display of claim 13, further comprising a layer for retaining the Braille characters.

20. The tactile display of claim 13, further comprising a source of addressable pulsed electrical current provided to the coils to move the drive pins between stable states.
